(19) United States
(12) Patent Application Publication
(10) Pub. No.: US 2017/0368749 A1
(43) Pub. Date: Dec. 28, 2017

(54) 3D PRINTER WITH REMOVEABLE RELEASE LAYER

(71) Applicants: ULRIK PILEGAARD, Woodland Hills, CA (US); TIMOTHY GRAHAM, Glendale, CA (US)

(72) Inventors: ULRIK PILEGAARD, Woodland Hills, CA (US); TIMOTHY GRAHAM, Glendale, CA (US)

(21) Appl. No.: 15/195,888

(22) Filed: Jun. 28, 2016

(51) Int. Cl. B29C 64/245; B33Y 30/00; B29K 67/00

(52) U.S. Cl. CPC B29C 64/245; B33Y 30/00; B29K 2067/046; B29K 2869/00; B29K 2855/02

(57) ABSTRACT

Disclosed is a 3D printer with a build platform configured to quickly and easily release a build object with no damage to the object. The build platform comprises a rigid frame; an adhesion surface configured to detachably attach to the upper side of the rigid frame; and rack assembly configured to attach to the bottom side of the rigid frame. The rigid frame includes a substantially planar plate of steel, while the adhesion surface comprises a flexible sheet material with an inherent concave curvature with the center biased toward the steel plate. Sets of clips and tabs integral to either the rigid frame or adhesion surface may be employed to releasable lock the frame and adhesion surface together. Sets of protrusions and dimples integral to either the rigid frame or adhesion surface may be employed to releasable lock the frame and adhesion surface together. To release a printed object, the user need only detach the adhesion surface from the rigid frame, and then twist the adhesion surface.

### CROSS-REFERENCE TO RELATED APPLICATIONS

This application claims the benefit of U.S. Provisional Patent Application Ser. No. 62/187,099 filed Jun. 30, 2015, titled “3D printer with removeable release layer,” which is hereby incorporated by reference herein for all purposes.

### TECHNICAL FIELD

The invention relates to a 3D printer with a detachable build platform. In particular, the invention relates to a build platform configured to easily release objects built with the 3D printer.

### BACKGROUND

One type of 3D printer extrudes thermoplastic onto a build platform as the extruder and build platform move laterally relative to one another. When the object being built is completed, the user must remove the object from the build platform by pulling at the object. If the object is delicate, or if the object is stuck to the build platform, the object may be damaged when the user attempts to remove the object from the build platform. There is therefore a need for a 3D printer in which the object can easily be release from the build platform without any damage to the object.

### SUMMARY

The invention in the preferred embodiment features a build platform for a 3D printer. The platform comprises a rigid frame; an adhesion surface configured to detachably attach to the top side of the rigid frame; and rack assembly configured to attach to the bottom side of the rigid frame. The rigid frame includes a substantially planar plate of steel, while the adhesion surface comprises a flexible sheet material with an inherent concave curvature with the center biased toward the steel plate. Sets of clips and tabs integral to either the rigid frame or adhesion surface may be employed to detachably attach the frame and adhesion surface together. Sets of protrusions and dimples integral to either the rigid frame or adhesion surface may be employed to detachably attach the frame and adhesion surface together.

### BRIEF DESCRIPTION OF THE DRAWINGS

The present invention is illustrated by way of example and not limitation in the figures of the accompanying drawings, and in which:

FIG. 1 is a perspective view of an extruder-based 3D printer with moveable build platform, in accordance with a first embodiment of the present invention;

FIG. 2 is a perspective view of the top side of a positioning mechanism with a moveable build platform, in accordance with a first embodiment of the present invention;

FIG. 3 is a perspective view of the underside of the moveable build platform, in accordance with a first embodiment of the present invention;

FIG. 4 is an exploded view of the moveable build platform, in accordance with a first embodiment of the present invention;

FIG. 5 is a bottom view of the detachable adhesion surface, in accordance with a first embodiment of the present invention;

FIG. 6 is a side view of the detachable adhesion surface, in accordance with a first embodiment of the present invention; and

FIG. 7 is a side view of the detachable adhesion surface, in accordance with a second embodiment of the present invention.

### DETAILED DESCRIPTION OF THE PREFERRED EMBODIMENT

The present invention pertains to a 3D printer with a build platform and extruder that move relative to one another in three dimensions. The printer includes a positioning mechanism configured to move the build platform horizontally in two directions and move the extruder vertically in response to a computer, processor, or other type of controller. A layer of object is printed or otherwise constructed by shifting the platform in the horizontal plane while simultaneously extruding thermoplastic material at a precise location onto the object being constructed. The build platform is shifted horizontally along the x-axis and/or y-axis to precisely position the object under a nozzle that extrudes the thermoplastic material. After a layer is printed, the nozzle and build platform are moved apart a small distance and the process of printing a layer repeated.

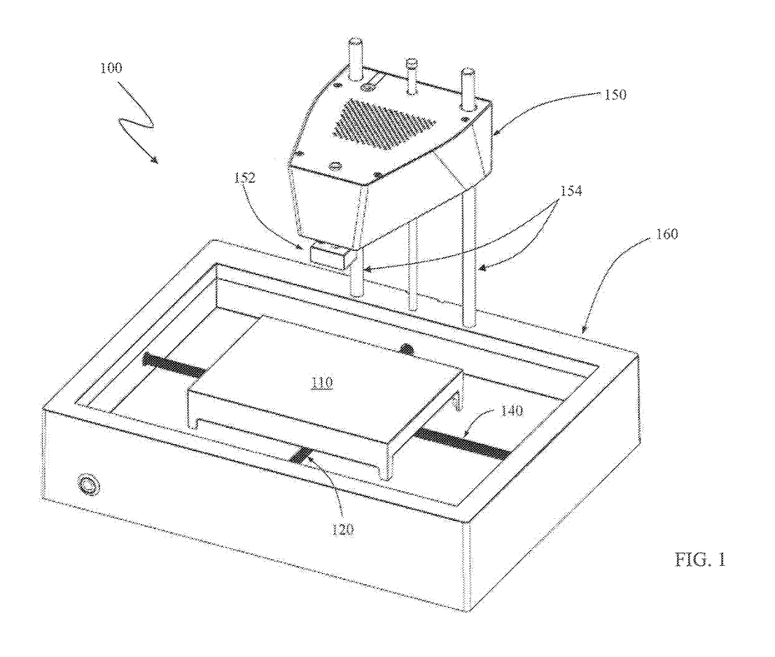

Illustrated in FIG. 1 is a preferred embodiment of a 3D printer 100 a thermoplastic extruder assembly 150, a moveable build platform or build platform 110, and a positioning mechanism. The positioning mechanism includes a frame 160, at least one actuator (not shown) for moving the extruder assembly vertically, at least two actuators (not shown) for moving the build platform laterally, and position controller (not shown) for energizing the actuators. The build platform 110 moves relative to the frame 160 in response to rotation of the pinion wires 120 and 140. The extruder assembly 150 includes a material feeder (not shown) for inputting raw thermoplastic material, a heating element (not shown) for melting the thermoplastic material, and an extruder head 152 for dispensing the thermoplastic material onto an object being constructed on the build platform 110. The position controller moves the platform in two dimensions as thermoplastic is dispensed from the extruder head to form a layer in the form of a 2D cross-section of the object, in the preferred embodiment. Successive layers are built by raising the extruder assembly relative to the build platform 110 using stanchions or arms 154.

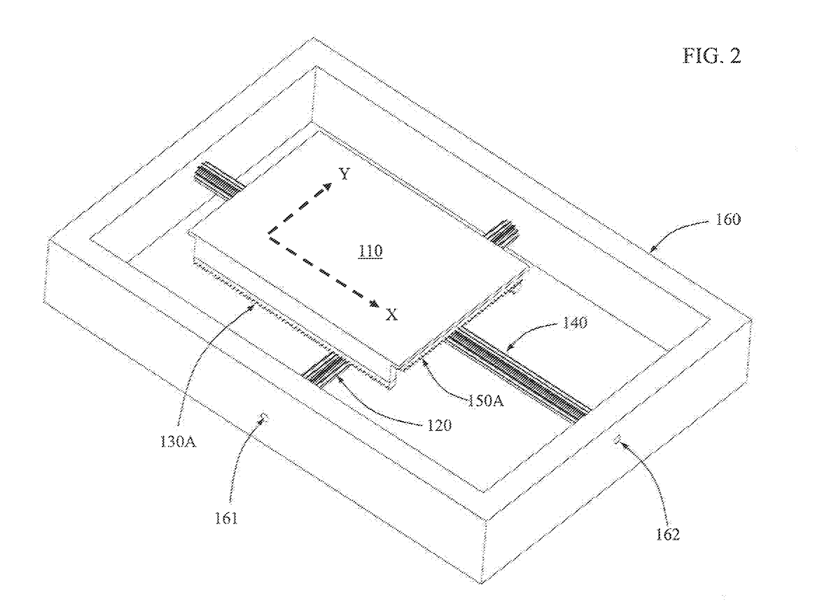

Illustrated in FIG. 2 is a perspective view of the upper side of the build platform 110 and frame 160. The build platform 110 includes a planar surface on the top and plurality of gear racks 130A, 150A underneath. The gear racks 130A, 150A each comprise a plurality of teeth arrayed in rows across the length and width of the build platform. The gear racks 130A and 150A, in turn, engage pinion wires 120 and 140, respectively, which carry the weight of the build platform as well as move the build platform laterally. The first gear rack 130A and pinion wire 120 serve as a first rack and pinion for moving the platform in the x-direction. The second gear rack 150A and pinion wire 140 serve as a second rack and pinion for moving the platform in the y-direction. The first rack 130A and pinion wire 120 operate substantially orthogonal to the second rack 150A and pinion wire 140. The pinion wires 120, 140 are independently driven by motors as disclosed in U.S. patent application Ser. No. 14/508,808 filed Oct. 7, 2014, which is hereby incorporated by reference herein.

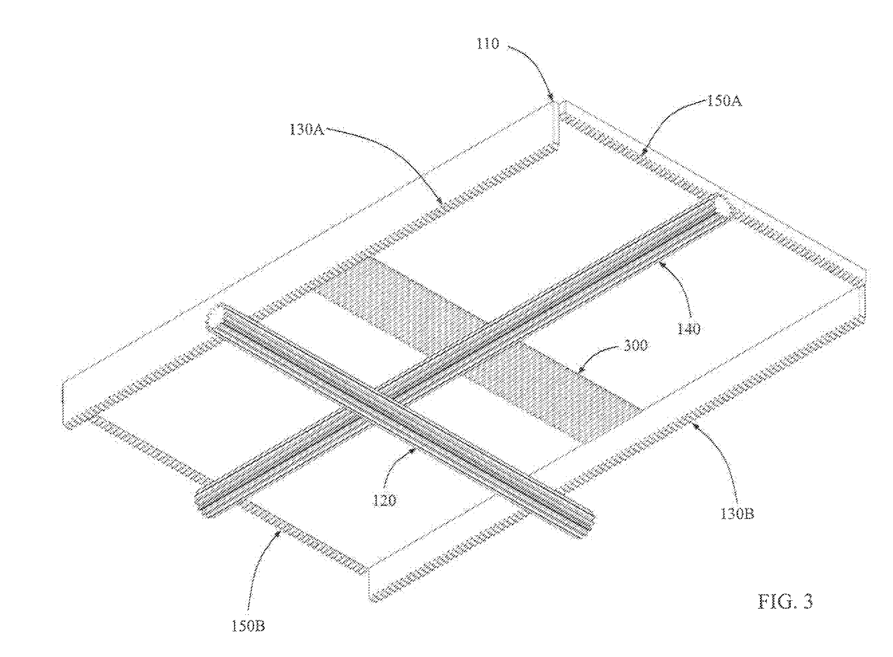

The underside of the build platform 110 and pinion wires are illustrated in FIG. 3. The first pinion wire 120 engages a first set of gear racks 130A, 130B. Similarly, the second pinion wire 140 engages a second set of gear racks 150A, 150B. To move to the upper right, for example, the first pinion wire 120 is rotated clockwise which drives the first set of gear racks 130A, 130B. While moving to the right, the second set of gear racks 150A, 150B are configured to slide along the pinion wire 140 in a direction parallel to the pinion wire 140. Similarly, to move the build platform 110 to the upper left, the second pinion wired 140 is rotated counter-clockwise which also causes the first set of gear racks 130A, 130B to slide over and against the first pinion wire 120. Because the two pinion wires are orthogonal, the build platform 110 can be driven in any direction in the horizontal plane by turning the two pinion wires at the appropriate rates.

FIG. 3 also illustrates an alignment rack, in accordance with one embodiment of the present invention. The alignment rack 300 is configured to ensure that the build platform 110 is properly aligned with the gear racks 130A, 130B, 150A, 150B when the user sets the build platform onto the pinion wires 120, 140. The build platform is properly aligned when the pinion wires 120, 140 are fully seated into the proper teeth of their respective gear racks. That is, the first pinion wire 120 seats with the nth tooth of both gear racks 130A and 130B, and the second pinon wire 140 seats with the mth tooth of both gear racks 150A and 150B.

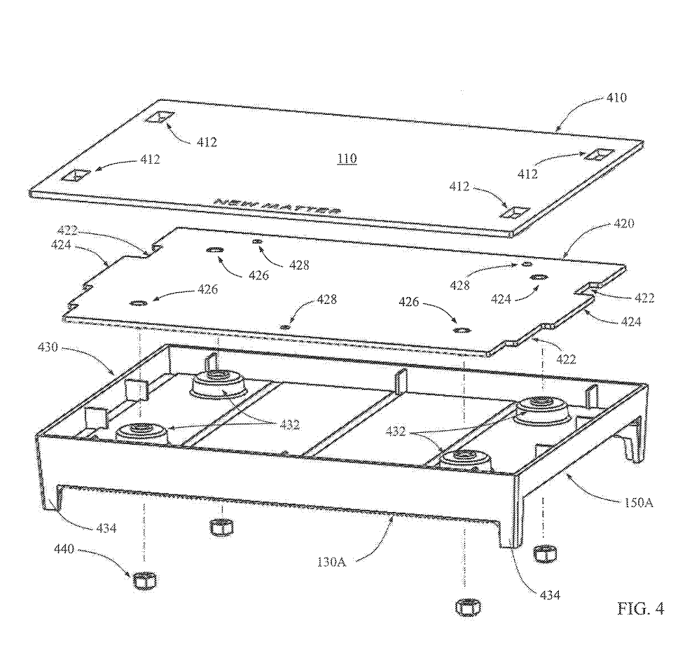

FIG. 4 is an exploded view of the moveable build platform, which consists of a rigid frame, a rack assembly, fasteners, and a detachable adhesion surface. In the preferred embodiment, the rigid frame 420 comprises at least one a metal plate or other planar member to which other structures can be securely attached. In the preferred embodiment, the metal plate is two millimeters thick and uniformly planar to within approximately 100 microns across the upper side of the plate. One skilled in the art will appreciate that the level of uniformity may vary depending on the application. In the preferred embodiment, the rigid frame comprises steel due to the fact that it is stiff and exhibits good thermal conductivity. The edges of the steel plate 420 include a pattern configured to attach to the adhesion surface 410. In the preferred embodiment, the adhesion surface includes clips 412 that drop through recesses 422 and slide under tabs 424 to secure the steel plate and adhesion surface together by means of a friction fit.

The steel plate 420 further includes a locking feature configured secure and level the adhesion surface over the steel plate. The locking feature includes a plurality of protrusions 428 on the top surface of the steel plate that coincide with dimples in the underside of the adhesion surface. The friction fit between the protrusions and the dimples prevents slippage of the adhesion surface and provides the user a tactile experience when locking the two pieces together.

The rack assembly 430 is configured to mount to the underside of the steel plate 420. In the preferred embodiment, the rack assembly includes apertures 432 configured to receive four threaded studs (not shown) that are pressed into holes 426, pass through apertures 432, and receive nuts 440. As described above, the rack assembly includes gear racks 130A and 130B (not shown) as well as racks 150A and 150B (not shown). A plurality of legs 434 are also configured to extend below the racks 130A, 150 where they protect the racks and provide a stop to limit the lateral range of the build platform.

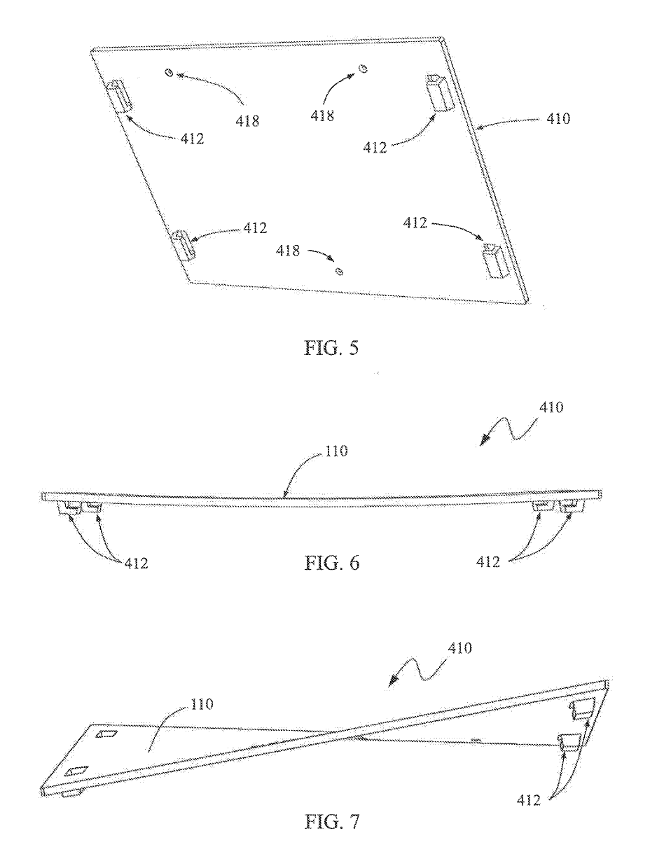

The adhesion surface 410, the bottom side of which is shown in FIG. 5 and side view in FIG. 6, is configured to receive molten thermoplastic directly from the extruder head 152.

The particular material from which the adhesion surface is made is selected to provide sufficient adhesion to hold the object being constructed to the build platform during product, in the preferred embodiment, the adhesion surface includes a polycarbonate-acrylonitrile butadiene styrene (PC/ABS) blend for use with PLA (polylactic acid) filaments.

The adhesion surface is, in turn, configured to clip to the steel plate by means of flanges 412 that capture tabs 424. As described above, the three protrusions 428 in the steel are configured to seat into dimples 418 to effectively lock the assembly together by means of a friction fit.

As illustrated in side view in FIG. 6, the adhesion surface in some embodiments includes a concave curvature to bias the center of the adhesion surface toward the steel plate. The concave curvature is molded into the adhesion surface at time of manufacture. When clipped to the steel plate, the adhesion surface is forced to flatten out and take the shape of the steel plate, thereby enabling the steel plate to control the flatness of the upper side of the adhesion surface.

When the 3D print operation is complete, the user has two options to remove the print from the adhesion surface. First, the user may simply grab the 3D object and pry it off the adhesion surface. Second, the user may slide the adhesion surface off of the steel plate and twist the opposing ends of the adhesion surface in opposite directions, as shown in FIG. 7. The twisting motion releases the 3D object with little effort and no damage to the part. In the preferred embodiment, the adhesion surface is configured to twist approximately three degrees per lineal length of the tray in response to a torque of about 15 to 20 lbf-in (pound force inches).

In some embodiments, the upper side of the adhesion surface 410 is textured to enhance the adhesion between the extruded material and the surface. A surface textured with peaks and valleys, for example, provides a larger surface than a flat, planar surface. In some additional embodiments, the adhesion surface includes a LEGO pattern of studs, tubes, and/or bars that serve as a mold for the bottom surface of the object being constructed, thus enabling the object to be mounted to LEGO blocks upon completion.

One or more embodiments of the present invention may be implemented with one or more computer readable media, wherein each medium may be configured to include thereon data or computer executable instructions for manipulating data. The computer executable instructions include data structures, objects, programs, routines, or other program modules that may be accessed by a processing system, such as one associated with a general-purpose computer or processor capable of performing various different functions or one associated with a special-purpose computer capable of performing a limited number of functions. Computer executable instructions cause the processing system to perform a particular function or group of functions and are examples of program code means for implementing steps for methods disclosed herein. Furthermore, a particular sequence of the executable instructions provides an example of corresponding acts that may be used to implement such steps. Examples of computer readable media include random-access memory (“RAM”), read-only memory (“ROM”), programmable read-only memory (“PROM”), erasable programmable read-only memory (“EPROM”), electrically erasable programmable read-only memory (“EEPROM”), compact disk read-only memory (“CD-ROM”), or any other device or component that is capable of providing data or executable instructions that may be accessed by a processing system. Examples of mass storage devices incorporating computer readable media include hard disk drives, magnetic disk drives, tape drives, optical disk drives, and solid state memory chips, for example. The term processor as used herein refers to a number of processing devices including personal computing devices, servers, general purpose computers, special purpose computers, application-specific integrated circuit (ASIC), and digital/analog circuits with discrete components, for example.

Although the description above contains many specifications, these should not be construed as limiting the scope of the invention but as merely providing illustrations of some of the presently preferred embodiments of this invention.

Therefore, the invention has been disclosed by way of example and not limitation, and reference should be made to the following claims to determine the scope of the present invention.

I/We claim:

1. A build platform for a 3D printer, the platform comprising:
a rigid frame;
an adhesion surface configured to detachably attach to the rigid frame; and
rack assembly configured to attach to the rigid frame.

2. The build platform of claim 1, further comprising one or more sets of clips and tabs integral to the rigid frame and adhesion surface for releasable locking the frame and adhesion surface together.

3. The build platform of claim 1, further comprising one or more sets of protrusions and dimples integral to the rigid frame and adhesion surface for releasable locking the frame and adhesion surface together.

4. The build platform of claim 1, wherein the rigid frame comprises a substantially planar piece of plate steel.

5. The build platform of claim 1, wherein the adhesion surface comprises a concave curvature.

6. The build platform of claim 1, wherein the adhesion surface is configured to flex to release a 3D printed object.

7. The build platform of claim 1, wherein the adhesion surface comprises a textured surface.

8. The build platform of claim 1, wherein the rack assembly comprises a plurality of gear racks.

9. The build platform of claim 8, wherein the plurality of gear racks comprises a first set of gear racks for moving the build platform in a first direction.

10. The build platform of claim 9, wherein the plurality of gear racks comprises a second set of gear racks for moving the build platform in a second direction, wherein the second direction is orthogonal to the first direction.
